(19) United States
(12) Patent Application Publication
(10) Pub. No.: US 2012/0041839 A1
(43) Pub. Date: Feb. 16, 2012

(54) SYSTEM AND METHOD FOR ASSEMBLY OF MODULAR TOY

(75) Inventors: Adrienne WEISS, Chicago, IL (US); Braulio F. PARAJON, Keller, TX (US); Lawrence S. ANDREINI, Fairfax, VA (US); M. David ARMSTRONG, City Richmond Heights, MO (US); Edward Jabbour, JR., Hastings-on-Hudson, NY (US); Donald W. AMADIO, Oaklyn, NJ (US); David G. WATKINS, City St. Charles, MO (US); David Wayne FINNEGAN, City St. Charles, MO (US); Lee NADLER, New York, NY (US); Rizal K. OEI, Scottsdale, AZ (US); Richard Dean DWYER, Phoenix, AZ (US); Yuk Kei CHAN, New Territories (HK)

(73) Assignee: RIDEMAKERZ, LLC, Falls Church, VA (US)

(21) Appl. No.: 13/281,822

(22) Filed: Oct. 26, 2011

Related U.S. Application Data
(63) Continuation of application No. 12/106,243, filed on Apr. 18, 2008.
(60) Provisional application No. 60/912,747, filed on Apr. 19, 2007.

(51) Int. Cl. G06Q 30/06

(52) U.S. Cl. 705/26.5

(57) ABSTRACT

A retail store design and method that allows a consumer, particularly a younger child, to actively participate in the customization, assembly, and personalization of a modular toy vehicle while in the retail store environment. The store design can provide an overall experience to the consumer that is interactive and personal. With this store design and method the consumer does not have to settle on limited off-the-shelf variations in toy vehicle design. The consumer can customize their own toy vehicle based on their own individual taste and also participated in the assembly process and personalize the vehicle including assigning a vehicle identification number (VIN) and creating a personalized license plate.

### RELATED APPLICATIONS

This application is a continuation of U.S. application Ser. No. 12/106,243, filed Apr. 18, 2008 which claims the benefit of provisional U.S. Application No. 60/912,747 filed Apr. 19, 2007, the entire disclosures of which are incorporated herein by reference.

### FIELD OF THE INVENTION

This invention relates generally to in-store retail processes and, more particularly, to an in-store experience involving self assembly of the item purchased.

### BACKGROUND INFORMATION

There are various types of customizable toys that are available to consumers for purchase. The consumer can select from a variety of styles or features to customize the toy to the consumer's individual preference. Often a consumer can select from a few options in order to vary a portion of the toy's main embodiment and then the customer can select from various accessories to further customize the item. For example, customizable dolls can be purchased, where the customer selects from various dolls that vary in skin color and eye color and other facial features. Then the consumer can select from various accessories to further customize the doll. There are business models that allow consumers to make these selections by way of catalog orders, by way of internet based orders, or by way of traditional in-store purchasing. However, with these business models, the consumer has very little if any involvement in the making or assembling of the product including its features and accessories.

There are a few in-store business models that allow the consumer to get more involved in the actual making or assembly of the finished product. For example, there are business models in the plush toy market that allow the consumer to become minimally involved, where the consumer selects an empty plush skin that is then provided to a retail store operator who stuffs the skin with a stuffing machine. The operator will stuff the plush toy and then return the item to the consumer. The consumer can then groom the fur of the plush and then select various accessories designed for the plush in order to further customize.

The construction and design of many toy items are designed primarily for assembly, including final assembly of the major components, in a non-retail manufacturing environment having trained skilled laborers and special tooling. This is even true for the final assembly stage of the multiple major subcomponents which contain the already assembled piece part components. Therefore, traditional assembly processes and toy construction designs have not been conducive for allowing the consumer to even perform the final assembly of the major sub components. Further it would not be effective to merely provide a consumer a bucket of parts and a set of directions and expect the consumer to assemble the item—much less enjoy the experience. This is particularly true for children for whom the toy is targeted. Younger children particularly would not be able to assemble many toy designs. Thus, previous business models have not allowed the consumer to actively participate in the assembly of their customized toy in a user friendly and effective way.

A business model and toy design is needed that allows the consumer, particularly children, to actively participate in at least the final assembly of the major subcomponents of a customized item. A business model is needed that provides the consumer, even younger children, the ability to actively participate in the assembly of the toy in a user friendly and effective manner.

### SUMMARY OF INVENTION

The invention is a retail store design and method that allows a consumer, particularly a younger child, to actively participate in the customization, assembly, and personalization of a modular toy vehicle while in the retail store environment. The store design can provide an overall experience to the consumer that is interactive and personal. With this store design, retail space layout, customer service representatives and method, the consumer does not have to settle on limited off-the-shelf variations in a toy vehicle design. The consumer can customize their own toy vehicle based on their own individual taste and also participated in the assembly process and personalize the vehicle including assigning an identification number which can be referred to as a ride identification number (RIN) and creating a personalized license plate.

The store design can include various stations, where each station is equipped and designed to accommodate a particular task within the overall process. The retail store space can have a floor plan and design that provides for a smooth transition of the consumer through each stage of the process and induces the consumer to follow a particular flow to accomplish the assembly and purchase experience. When a consumer enters the retail space, the consumer, if desirous of purchasing a custom vehicle can be directed by way of retail space layout having strategically positioned aisle pathways and barriers and/or directed by a customer service representative to a toy vehicle body selection station including a display rack having segregated display channels formed by side supports for displaying vehicle body styles contained in packaging, and arranged in vertical stacks segregated by body style by said side supports. At this station the consumer can view the various body styles and select a preferred body style.

The consumer can transport the selected body style to a template sampling station proximately adjacent said vehicle body selection station. The sampling station can include a template toy vehicle chassis that has outer dimensions substantially the same as an actual mating toy vehicle chassis for test fitting a selected body. The template vehicle can essentially be substantially identical to an actual mating chassis that will be ultimately purchased as part of the modular vehicle, particularly its exterior profile can be dimensionally identical. However, the template vehicle can be in some manner affixed to the station such that a template is not mistakenly removed and to assure that the template is available for subsequent consumers. The consumer can remove from the packaging and place their selected body style over the template in order to capture a better visualization of the appearance of the final product. Multiple chassis template styles can be provided that correspond to actual chassis styles. For example, there can be a street chassis design (gives the appearance of a standard car chassis) and an off-road chassis design (gives the appearance of an off-road vehicle or raised truck chassis).

The consumer can go to a sound module station, which can be positioned in the retail store environment and proximate the chassis template station and contained along a common flow pathway as the body style station and the template station. The sound module station can include an electronically integrated sub system including a built in speaker system, an electronic storage and playback system for storing and playing back sound clips. The station can also include a selection interface for receiving consumer selections to sample sound clips and corresponding drawers containing sound modules. The selection interface can comprise multiple selection mechanisms, such as for example, buttons that are electronically actuated when depressed. The buttons can be numbered to correspond to stored sound clips. When a button is depressed, the playback system can audibly playback the sound clip through the built in speaker system. The consumer can retrieve a selected sound module from the appropriate drawer containing the modules once a preferred sound clip has been chosen.

The consumer can transport the selected body and selected sound module to a component collection station having a storage of chassis styles for consumer pickup. The component collection station can be constructed to appear like an auto body parts shop. The consumer can at this point obtain the selected chassis style from among various styles. For example, the chassis styles can include motorized standard car chassis, non-motorized (free wheel) standard car chassis, motorized raised truck chassis and non-motorized raised truck chassis. Various other chassis styles can also be provided without departing from the scope of the invention. The consumer can transport all of the selected items to an assembly station having custom tooling adapted to interface and drive an attachment member, which is adapted to attach the vehicle chassis to the vehicle body. The assembly station can have a work bench for assembling the items and can have customized tooling for driving and/or tightening, such as for example a powered wrench, an attachment member such as for example a threaded bolt. The assembly station can also include a timer function that can start and stop a timer in order to time how long it takes the consumer to complete the assembly process.

As an alternative, a slightly modified flow can be utilized where the component collection station and the assembly station can be combined where the chassis styles can be stored at the assembly station, therefore, removing the need to have a separate collection station. A customer service representative can be position at the this combined station to assist in distributing the chassis and assisting a purchaser in the assembly process.

An accessory station including a display having a display board for displaying accessory items and a work bench for in-store sampling and installing accessories can be positioned proximate the assembly station. The consumer can take the assembled vehicle to the accessory station and try out various accessories in order to make purchase selections. This station can be visited by consumers who have already purchased vehicles during a previous visit to the retail store or are visiting the store just to browse or desire to further customize a vehicle being purchased during a current visit.

The retail store space can also include a personalization station having computer work stations and integral toy garages sized for insertion of the toy vehicle and having a reader operable to scan and interpret an encoded identifier placed on or affixed in some manner to the vehicle body and or chassis. Each body and/or chassis can include a bar code, radio frequency identifier (RFID), or other encoded identifier that has encoded therein identifying information relating to various features including the selected body style, the color, and the selected chassis type.

An encoded identifier can be attached to the vehicle body and/or vehicle chassis. One reason for possibly having an encoded identifier on both the body and the chassis is to separately identify the body and chassis type and features. The encoded identifier can be read and interpreted by the reader and the reader can be further operable for transferring the vehicle body style information obtained from the encoded identifier to the computerized work stations where said work stations can be operable to create an electronic record or profile in memory containing body style information, other vehicle information and consumer information. The computerized work station can be designed to receive other vehicle related information input by the consumer including information relating to accessories installed and add the information into the record. For example, the accessory information can be input by the consumer by scanning an identifier on the accessory packaging, thereby adding the scanned accessory to the final configuration stored in the profile.

The record or profile can be assigned an identifier, such as for example, an alphanumeric designator or RIN (ride identification number), that is directly correlated to the profile and the associated resulting toy vehicle configuration. The RIN number format and content can be created from information entered by the purchaser. For example, the RIN number could be a uniquely created data string having one or more data strings embedded therein including for example—Point Of Sale Identifier (ID for a given retail store); transaction identifier; Body Style ID; Chassis Style ID; Consumer Birth Date; Transaction Date/Time Stamp; and etc. . . . The profile can then be identified or labeled by the uniquely created RIN; and the profile can include, for example one or more of the following—Consumer Name; Consumer Address; Consumer Birth Date; Consumer Email Address; and etc.

The profile including the associated information such as the RUN, selected component identifiers and any other entered data can be stored for future retrieval. The profile or record can be temporarily be stored locally at the computerized work station and then periodically uploaded to a centralized computing system having a database for storing profile information. The consumer can also assign a nickname, which can be placed on a toy vehicle license plate. The toy license plate can be a sticker with a printed graphic of the nickname for placing on the vehicle to simulate a personalized license plate. Graphical data or an Avatar for a computerized graphical representation of the customized toy vehicle can also be created. The Avatar can be created a plurality of different ways including for example real time creation at the local work station and presented to the purchaser and subsequently uploaded to the centralized computing system; or the Avatar can be created by a centralized computing system and stored in a data base that can be accessed later by the purchaser on-line.

The garage portion of the personalization station can be sized such that the consumer can insert there customized vehicle and the reader can be operable to scan and interpret the encoded identifier. The garage can have one or more readers scanning from various angles and perspectives. The garage can also be used to scan accessory packages as discussed above

The in-store process and experience can begin when the consumer decides to purchase a new customized vehicle. The consumer can begin by selecting in the retail store a select toy vehicle body style from the toy vehicle body selection station, which includes a display rack having segregated display channels formed by side supports for displaying vehicle body styles contained in packaging, and arranged in vertical stacks segregated by body style by said side supports. The consumer can select a body style from one of the many stacks. The consumer can take the selected body style and begin test fitting the selected toy vehicle body style at the template sampling station proximately adjacent said vehicle body selection station. The sampling station can include a template toy vehicle chassis having outer dimensions substantially the same as an actual mating toy vehicle chassis. The consumer can begin placing the selected body style over the various chassis selections in order to better visualize and make a chassis selection.

The consumer can begin sampling sound clips and selecting a sound module in the retail store at a sound module station including a built in speaker system, an electronic storage and playback system for storing and playing back sound clips, a selection interface for receiving consumer selections to sample sound clips and corresponding drawers containing sound modules. Once at the sound module station, the consumer can begin selecting sound clips for audible review. The audible review of the sound clip hopefully assists the consumer in making a selection for a sound module. The consumer can begin receiving in the retail store an actual selected chassis at a component collection station having a storage of chassis styles for consumer pickup; or as an alternative flow the consumer can collect the selected chassis at the assembly station.

The consumer can begin assembling the modular toy vehicle components selected in the retail store at an assembly station having custom tooling adapted to interface and drive an attachment member. The consumer can make further accessory selections by sampling and installing accessories in the retail store obtained at an accessory station including a display having a display board for displaying accessory items and a work bench for in-store sampling and installing accessories. The consumer can also begin personalizing the modular toy vehicle in the retail store at a personalization station having computer work stations and integral toy garages sized for insertion of the toy vehicle and having a reader operable to scan and interpret an encoded identifier.

These and other advantageous features of the present invention will be in part apparent and in part pointed out herein below.

### BRIEF DESCRIPTION OF THE DRAWINGS

For a better understanding of the present invention, reference may be made to the accompanying drawings in which:

FIG. 1 is a process flow of the in-store business model;

FIG. 2 is an overhead plan view illustrating the retail floor layout and flow;

FIGS. 2A and 2B are illustrations of alternative embodiments for the retail floor layout and flow;

FIG. 3 is a view of the station for choosing the body style;

FIGS. 4 and 4A are views of the station for assembling the vehicle; and

FIG. 5 is a view of a station for customizing the vehicle.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION

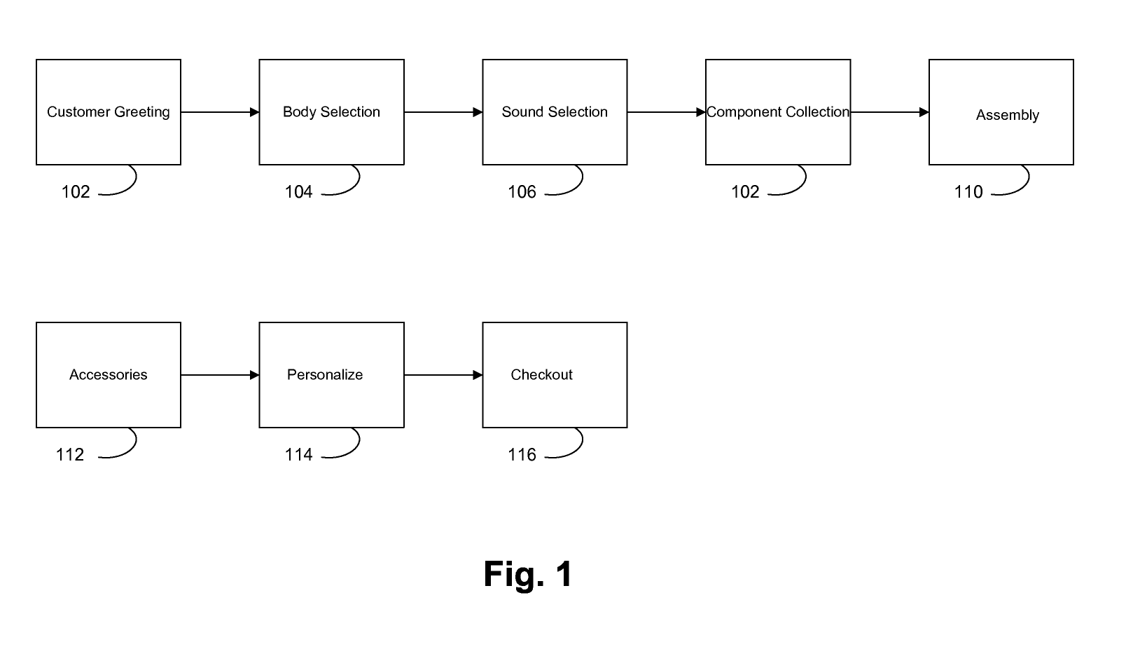

According to the embodiment(s) of the present invention, various views are illustrated in FIGS. 1-5 and like reference numerals are being used consistently throughout to refer to like and corresponding parts of the invention for all of the various views and figures of the drawing. Also, please note that the first digit(s) of the reference number for a given item or part of the invention should correspond to the figure number in which the item or part is first identified.

One embodiment of the present invention includes a modular toy vehicle design having easily assembled modular components and an in-store consumer selection and assembly process teaches a novel apparatus and method for allowing a consumer to select and customize a toy vehicle and assembly the selected components in a retail environment

The details of the invention and various embodiments can be better understood by referring to the figures of the drawing. Referring to FIG. 1, a process flow of the in-store business model 100 is shown. The process flow shows various stages of the in-store experience as a consumer smoothly transitions between the stages of selecting, customizing, assembling, accessorizing and personalizing a modular toy vehicle designed based on their selections. The consumer's transition between the stages or stations is directed by the retail space floor plan and/or a customer service representative. Although FIG. 1 illustrates a particular sequence of the stations, the station can vary in sequence without departing from the scope of the present invention. For example, the Accessory step 112 can come before or after the Assembly step 110 or two steps can be integrated together to allow the customer to actual install the custom accessories during the assembly process. Another example would be if a customer has already purchase a vehicle during a previous store visit and has returned only to pick out some additional accessory item, in which case the customer may proceed to the accessory station as directed by the retail space floor plan. Yet another alternative is to combine the step of component selection and the step of assembly into one step.

The Introduction/Greeting step is reflected by functional block 102. Upon entering the retail space, guests can be greeted by an individual who can familiarize the customer with the in-store experience and get the customer started in the process. This individual can generally be referred to as the Customizer or customer service representative who, using the entry floor display as a visual aid, shows the guests the process by which the modular toy vehicles are created. The customer service representative can explain how the retail space floor plan is designed to direct the customer through the process. Arrows, colored pathways or other indicia on the floor or signs can be utilized in combination with the retail space floor plan having barriers and aisles to direct the customer through the process. Customers can be directed to pass through a simulated “Shop” door (garage like, auto-body/mechanic shop door) and into the toy vehicle body selection station. The body selection station can be an elongated aisle having only having openings on the entrance end and the exit end.

The toy vehicle body selection stage is indicated by functional step 104, where a wide selection of vehicle body styles can be displayed, in various colors and degrees of paint finish. Vehicle bodies (shells) can be stacked vertically in specially designed bins and arranged by make and model, as well as by color. For example, each vehicle can be offered in a certain number of color options including solid colors and “custom” paint finishes. Bodies with extensive painting and detailing can carry a higher retail price than the more basic solid colored vehicle bodies. Directly above each vehicle body bin can be displayed samples of that particular vehicle in its fully assembled “stock” form. The stock configuration can consist of the vehicle body on a car or “street” chassis, four stock tires, four stock rims and a fifteen-second sound chip or sound module which plays a mix of car sound effects and music. With the exception of the certain lower-priced vehicles, the remaining vehicles can be equipped to have working headlights and tail lights in addition to the sound feature. The various body styles can have uniform chassis interface mating designs such that all body designs can mate with the same chassis design.

Once customers select their vehicle body and remove it from the bin they can proceed to chassis template sampling station as directed by the retail space floor plan. Here customers can see how their selected vehicle body will appear on various chassis styles, for example, both a “street” chassis and a “monster”/off-road or raised truck chassis. The “street” chassis can be considered a stock item and therefore included in the base price of the vehicle. The “monster” chassis can carry an additional charge. The actual chassis to be purchased are stored elsewhere in the store, therefore, the customer can select from one of a plurality of “tokens” to signify the chassis they have chosen for their Ride. For example, a low-profile car tire token can represent a “street” chassis and a monster truck tire token can represent the “monster” chassis.

The retail space floor plan can direct the customer to a sound module selection station 106, where customers can have the option of listening to and selecting additional sound modules for their vehicle in addition to a standard stock sound module, which can be provided as part of the standard purchase. The sound module selection station can be along a common aisle with the body selection station and on the exit end of the aisle with respect to the body selection station in order to direct the flow of the consumer. For example, in addition to the sound module that is included with a standard purchase, there can be a plurality of additional sound module choices, and each can be for example 30 seconds in length or longer, which can be purchased separately. The sound module selection station can be designed, for example, like a kiosk that resembles a speaker display similar to those typically seen in car audio department of an electronics store or in a car audio store. By pressing buttons on a display, customers can hear the full 30 second playback from each chip. The actual Modules can be stored in drawers that are built into the display (for example—disguised as speakers). Once the customer makes his selection(s), he can open the drawer(s) and can remove the desired sound module.

The retail space floor plan can be designed to direct the customer to a station that can resemble an auto parts service counter and can be staffed by a customer service representative. This step can be referred to as the component collection step 108. The customer can collect the actual chassis to be purchased at this station. The customer can hand the service representative for this station their vehicle body, chassis token and any sound modules they have chosen. The service representative can ascertain whether the customer wishes for their vehicle to be “freewheel” or “radio-control” (motorized—which is an upgrade). Once this decision has been made, the customer service representative at this station has all the information needed to determine which chassis to pull from stock (chassis inventory is located proximate the component collection station.) The service representative can pull the appropriate chassis from stock. A stock room for storing the various chassis can be located behind this station. The service representative can empty the contents of the chassis box into a basket, which the customer can take to the Assembly area. Also placed in the basket can be the vehicle body and sound module.

The retail space floor plan can direct the customer to the assembly step 110, performed at the assembly station. As customers approach the assembly area, they can view a brief video that demonstrates the assembly process. The video will provide instructions on how to utilize the specialize tools provide at the station for assembly of the vehicle. The video can be presented on a large flat screen monitor located directly over the assembly workbench and plays on a continuous loop, so customers who join the video in mid-session will have the opportunity to view the entire presentation again in a matter of minutes. They can also be introduced to the timed assembly Pit Challenge—a timed competition that consumer can take part in as part of the assembly process. As discussed above, the assembly station and the collection station can be combined into one station where the chassis are stored at the assembly station. Also the collection station and the assembly station or the collection/assembly combination station can be located in the floor plan proximate the exit end of the body selection aisle, again to urge the flow of the purchasers along the desire path of the in store process.

The consumer can start and stop a timer made available at the assembly station, that can allow the assembly time of each consumer to be timed. A display can be provided which shows the elapsed time. A display can also be provided listing the names of the consumers with the fastest assembly times. The timed assembly competition can be referred to as the RZ Pit Challenge where a timed competition is conducted in which customers compete against the clock to see how quickly they can assemble their vehicle. In order to assemble the vehicle, consumers can use a powered screwdriver or powered wrench with a special bit to drive the attachment member, such as for example as a threaded bolt, to quickly and easily assemble their vehicle. The wheel assembly is a simple snap-on process that requires no tools. Immediately prior to assembly, customers will press a button to activate a stopwatch that is built into the assembly table . . . and will again hit the button to stop the timer when they have finished assembling their car. Their time/score is recorded onto a card by the Pit Challenge Crew Member, service representative, and handed to the customer. Alternatively the Pit Challenge can be automated to provide print out of timed scores.

At another station in the process, the personalize station, the customer can be prompted to enter their time in the computer in order to receive their RZ Pit Challenge score and pit ranking. With their time card and assembled toy vehicle back in their basket, the customer can be directed to the customize accessory station to view the various customizing accessories and decorating options. Again, as discussed above, the Accessory station can be after, precede, or an integral part of the Assembly station.

A step in the process can be the accessorizing step 112 where customers can move through an accessory station, as directed by the retail space floor plan, including a display having a display board for displaying accessory items and a work bench for in-store sampling and installing accessories. Several displays of aftermarket accessories to customize and decorate their modular toy vehicle, such as for example—Rims, Tires, Exterior Accessories and Decals. Instructional displays can be provided to inform customers of the locations of the universal accessory mounts and to provide visual and written instructions on how to install the accessories at those locations on the vehicle. Customers can be encouraged to customize and decorate their vehicle in-store. A customizing bench can extend the length of the station and service representatives can be available to assist customers with accessorizing and decorating their vehicles. Again, the Customizing and/or Accessory stations can be an integral part of the Assembly station or located proximate the assembly station, again to urge flow along a particular path.

Included in the base price of each vehicle can be a set of stock rims. These rims can be molded having a single color, for example, solid black and can have the emblem or logo of the retail store. However, customers can customize their vehicles by replacing these rims with a selection of unique rims that are available in bright chrome and in chrome plus an accent color. Full size (for example 18″ diameter or other standard size rim for a real automobile) representations of all rims can be displayed on the wall next to actual merchandise. Samples of vehicles with various rims can line the upper portion of the display. The rims can be packaged in sets of two (2) in easily opened and recloseable clamshell blisters to facilitate sampling.

Customers can also upgrade from the stock black tires to a number of specialty tires with custom tread patterns. The tires with custom tread designs can be available with unique 2-color treads designs and that can have extra deep treads with powerful iconic tread patterns. Full size tires having the custom tread design samples can protrude from the wall to highlight the unique tread designs. Tires can be sold in sets of two (2) and merchandized, by size, in one or more bins located directly beneath the wall display.

Customers can decorate and detail their cars with a wide selection of vinyl decals. These decals can be designed to be easily removable and repositionable and designed not to leave sticky residue on the vehicle body, and can be available in a variety of themes for both boys and girls. The decals can be available individually or packaged by theme. The accessories can be designed to fit all vehicles purchased in the store and can be interchangeable between vehicles. Accessories can be attach to the front, sides and rear of the vehicles via a tab-slot system and to the roof and hood of the via hidden magnets. All items can be packaged in easy open and recloseable clamshell blisters. Customers can be encouraged to customize and decorate their toy vehicles in-store. A customizing bench can extend the length of the CUSTOMIZE accessory station and customer representatives can be available to assist customers with accessorizing and decorating their toy vehicles. Customizing tips posters and dozens of customized vehicle samples can be displayed to help customers with customizing ideas.

A step in the process can be the personalize step 114 where a customer is directed to move through a personalization station having computerized work stations and integral toy garages sized for insertion of the toy vehicle and said garages having a reader operable to scan and interpret an encoded identifier where said readers are communicably linked to the computerized work station. The readers can be for example optical readers for scanning and interpreting bar codes or RFID readers. Each vehicle chassis and body type can have an encoded identifier attached that provides specification of that type body and chassis. The personalize station can be proximate the checkout station and along a path on an end closer to the entrance with respect to the assembly station, thereby urging the consumer toward the personalize station as the proceed to check out and toward the entrance of the retail space when ready to depart.

The toy garages can have an integral reader for reading the encoded information. The personalize station can consist of several computer workstations where customers register their vehicle. Customers can enter information about themselves and their vehicles to create a vehicle Title with its own unique R.I.N. (Ride Identification Number) and personalized License Plates for their vehicle. For example, if the customer has added accessories at the accessorizing station, the customer can enter the accessory information at this point. The computing system can also be equipped to display a visual depiction of the customized vehicle. A color printout or wall size poster can also be provided. The customer can later view this image on-line and forward the image via Email to others. This R.I.N. number can later to used to access information about that specific vehicle online at web site and to gain special access to online activities and games. The customer can also have the option to give the vehicle a name.

The personalize station can comprise several computer workstations where customers register their toy vehicle. Once seated at a terminal, customers can be prompted to “park” their vehicle in their toy garage, or “carport” that is attached to the left or right side of the workstation. The garage can house an internal laser scanner that scans the barcode sticker that is affixed to the body of each vehicle. Other encoded tags and readers can be utilized. The barcode identifies the model and color of the vehicle. Additionally customers are asked to identify the type of chassis they selected and which rim design they chose to put on their vehicle. As this data is captured, the computer can be operable to build an image of the customer's vehicle on the screen; body, color, chassis, rims. This same process is used to create the vehicle's unique RIN (Ride Identification Number). Customers can then be prompted to enter information about themselves in order to complete the creation of a vehicle Title and personalized License Plates. This registration process creates a RIN number that can be utilized later to access information on-line at a designated web site about that specific customized toy vehicle that was purchased and to gain special access to online activities and games.

A checkout step 116 can be provided where the customer proceeds to a checkout station to complete the transaction. This is the “checkout” area where purchase transactions are made. Customers receive their printed vehicle Title and License Plates at this station. The vehicles can be placed inside of a “Cruize Case”, a cardboard carrier for their vehicle that resembles a shop mechanic's toolbox, for transport home. The customer can also order wall-size posters of their vehicle at this time as well as other items.

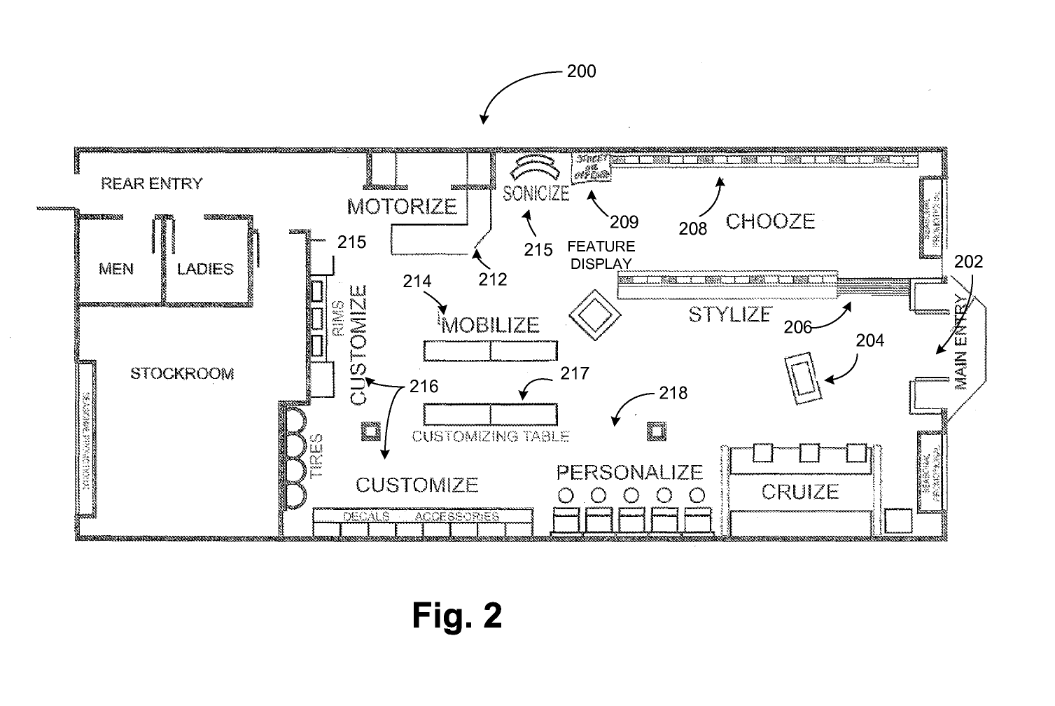

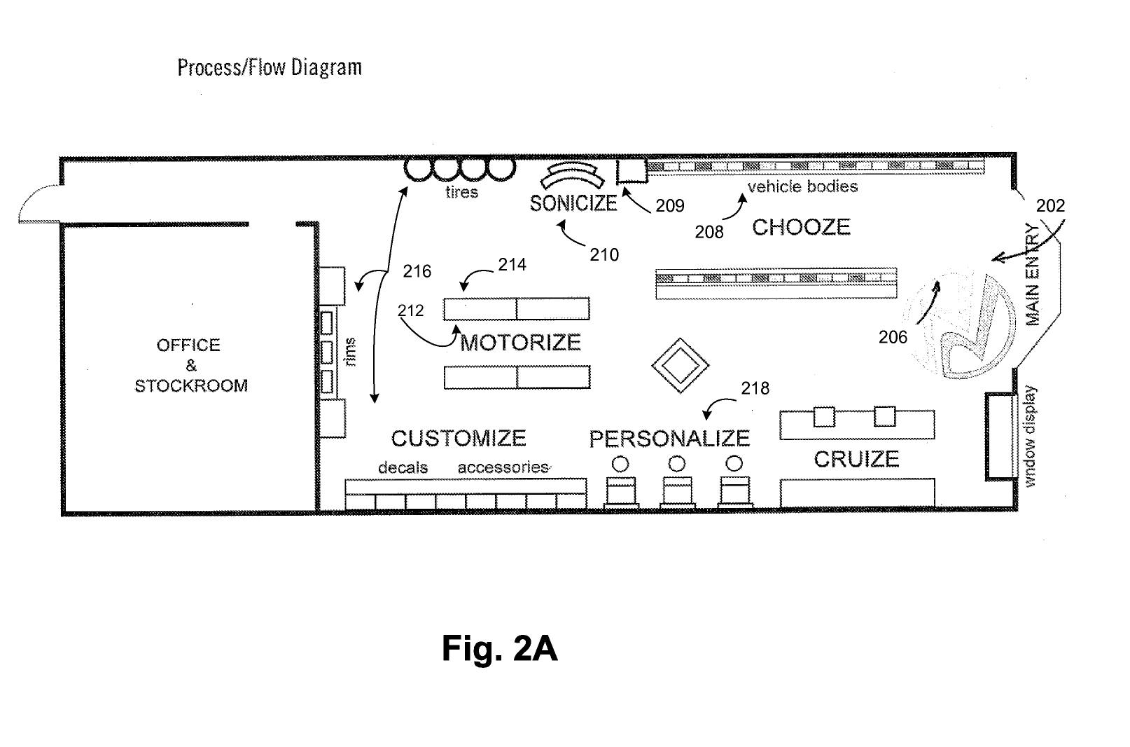

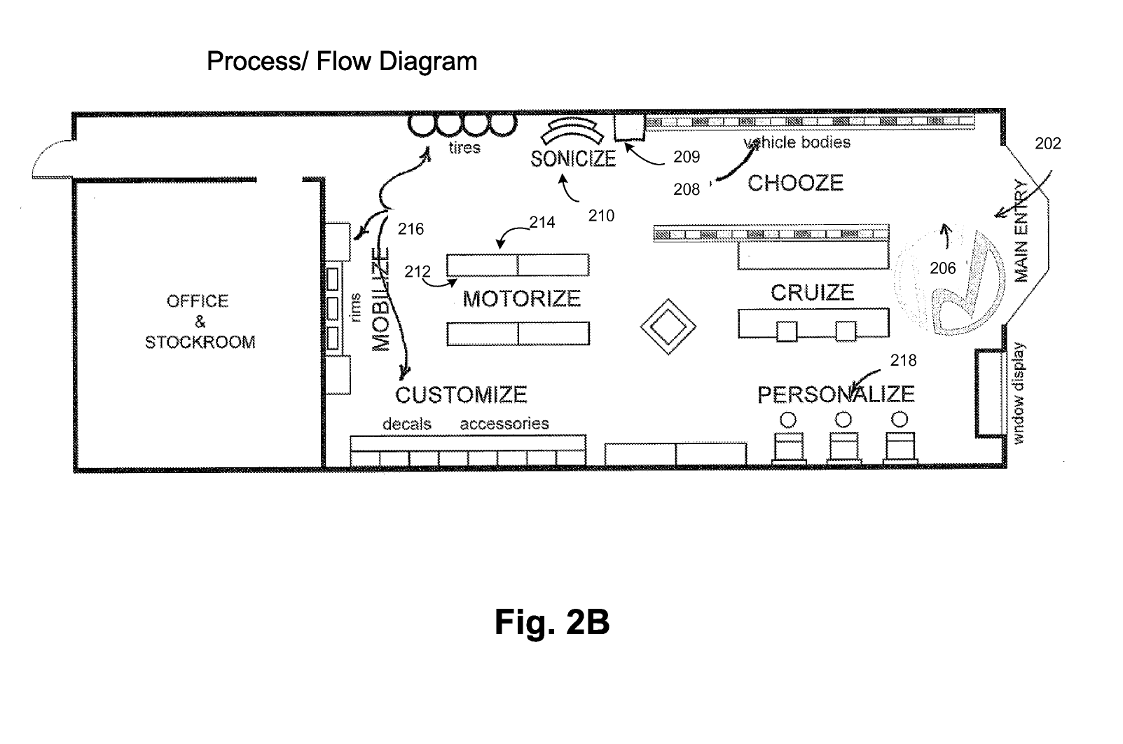

Referring to FIG. 2, an overhead plan view of the retail floor layout 200 is shown. Various stations can be strategically placed within the floor plan in order to provide a smooth process flow as well as providing an enhanced customer experience. Various fixtures and displays can be placed throughout the retail space to give the retail space the look and feel of an auto mechanic's shop or garage. The primary stations can be placed along the perimeter of the retail space in order to control customer traffic moving throughout the retail space. The retail space floor plan, display construction and arrangement can be designed to create a customer flow path that directs the customer along a path adjacent the various stations in a manner conducive to the selection, assembly, customization and personalization/registration of the vehicle for purchase. A customer can enter through an entrance 202 and proceed to a greeting station that can be proximately located with respect to the entrance. At the greeting station 204, a customer service representative can provide instructions to the customer as well as directing them to the appropriate station. The positioning of the greeting station and the entrance 206 within the retail space floor plan tends to channel the customer to the vehicle body selection station. Other fixtures or barriers can be utilized to direct or urge the customer along a particular flow path.

The customer service representative can direct a customer through an entrance 206 to the entrance of the customization experience. The toy vehicle body station 208 is shown against a side wall of the retail space within an elongated aisle having an entrance end proximate the entrance to the retail space and the greeting station and a distal exit end. Included in the selection station 208 is a template sampling station 209 provided to allow the customer to decide on a chassis style. Adjacent the selection station is a sound module station 210 where the customer can decide on a sound module selection. The sound module station is also positioned against one of the side walls of the retail space. The template station and the sound module station can be along and within a common aisle with the body selection station proximate the distal exit end of the aisle in order to direct consumer flow along the desired path.

Alternatively, one or both of the template station and sound module station can be outside of the aisle though still proximate the distal exit end. Adjacent the sound module station against a side wall can be the component collection station 212 where a customer can receive the selected chassis. This portion of the retail space floor plan labeled in FIG. 2 as the CHOOZE, SONICIZE and MOTORIZE areas for illustrative purposes is arranged and designed to create a customer flow path that directs the customer along a path adjacent the various stations in a manner conducive to the selection and assembly process. However, as discussed above the collection station 212 and the assembly station 214 can be combined into one station as illustrated by FIGS. 2A and 2B.

The assembly station 214 is shown at a location proximate the component collection station 212 toward a central area of the retail space. The customer can assemble the modular vehicle at the assembly station. The accessory station 216 is shown positioned against rear walls of the retail space. The accessory station can provide various accessories to further customize the modular toy vehicle. In addition, the accessory station can provide full size rims on display 215 for the customers' viewing. The customers can select from these rim designs on display. The play sized version of these full sized rims can be available for purchase. The accessory station 216 can provide a workbench 217 for installation and sampling of the various accessories. The Accessory stations 215 and 216 can be arrange in a more parallel arrangement to create a channel directed toward or about the Assembly station 214. The areas labeled MOBILIZE and CUSTOMIZE can be designed to be more integral or sequential.

The personalized station 218 can be arranged against a side wall of the retail space and can be position along a path between the assembly station and the entry of the retail space and proximate to the checkout station, which is labeled as the CRUIZE station. The personalized station can include multiple computer work stations having integral toy garages sized for insertion of the toy vehicle where the toy garage has a reader operable to scan and interpret an encoded identifier attached to the vehicle. The checkout station 220 can be positioned against a side wall proximate the entrance of the retail space.

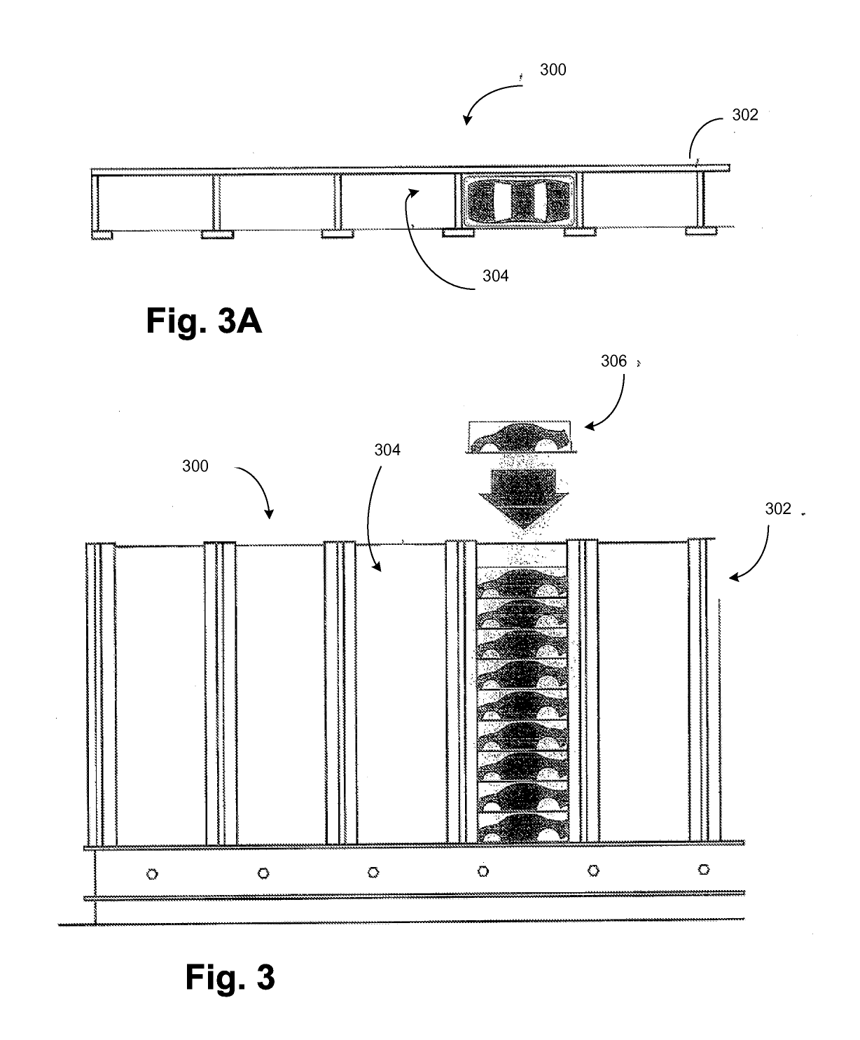

Referring to FIGS. 3 and 3A, an illustration of the body selection station 300. The selection station includes a display rack 302 having segregated display channels 304 or sections formed by side supports having a frontal opening for displaying the vehicle body styles contained in specialized packaging 306. The display rack can alternatively have a forward facing dispensing slot at the bottom of each channel. The rack can also include a facial wall to hide the upper portion of the slot use for extra storage. The various body styles can be packaged and arranged in vertical stacks segregated by body style by side supports. The template sampling station can be adjacent and can have a platform supporting a template toy vehicle chassis having outer dimensions essentially the same as an actual mating toy vehicle toy chassis for test fitting a selected body. A customer can remove a selected body style from its package and place the body over the template to determine how the body style will look when placed over an actual chassis. The sound module station can include a display panel having buttons that can be depressed in order to select a sound clip for review. The sound module station can include built-in speakers for playback of the sound clips.

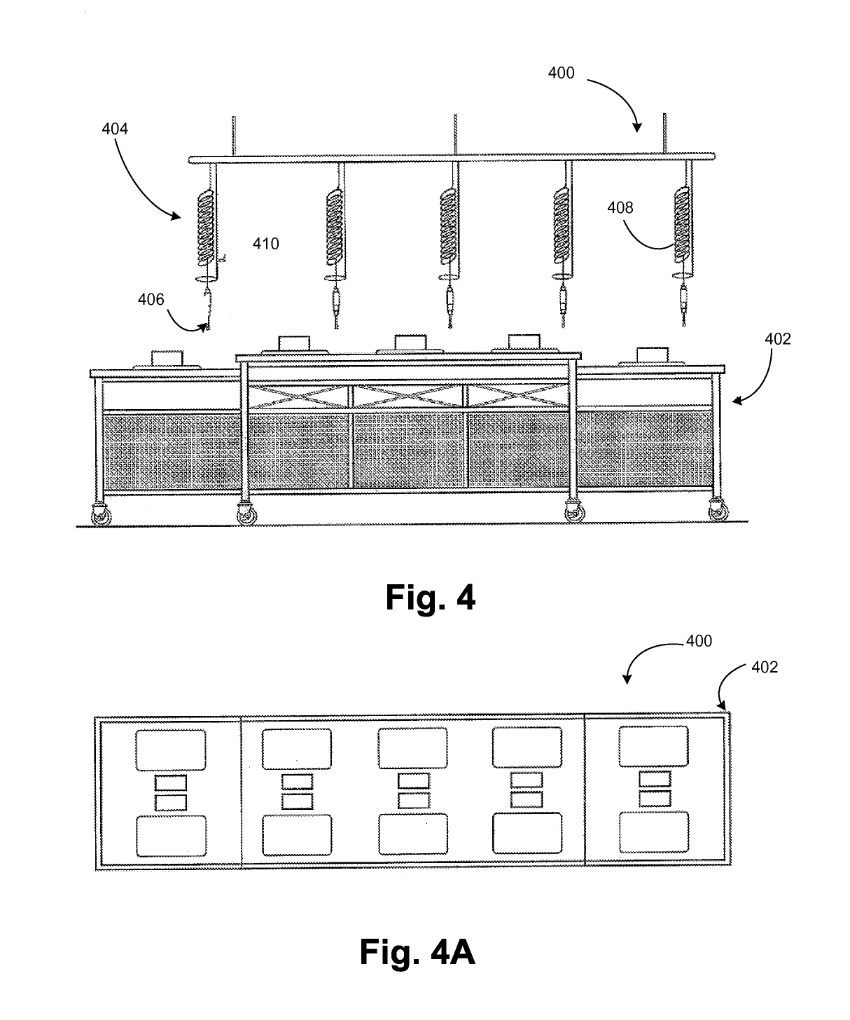

Referring to FIGS. 4 and 4A, an illustration of the assembly station 400 is shown. The assembly station is shown having a workbench 402 for assembling the modular toy vehicle. The assembly station also includes specialized tooling 404 to assist in the assembly process. The tooling can be suspended above the workbench area, whereby the customer can grasp the tooling and pull downward for engaging the tool 406 with the appropriate attachment members. The tool 406 can be extended from a coiled line 408 that retracts and urges the tool upward to a stowed height. However, the coiled line can be extended down by the operator in order to perform assembly.

For safety reasons, a retaining loop 410 is used to prevent the tool 406 and the coil line 408 from being extended laterally between the assembly work stations. The retaining loop 410 can be a rod like member can have an elongated straight extension portion that extends vertically downward in a substantially parallel manner with respect to the vertical cylindrical axis of the coil line and can have a loop portion that is horizontally oriented and loops about the coil line (said coil line is inserted through the loop such that the tool hangs below the loop). A stop member that is too large to pass through the loop can be attached to the coil line and positioned beneath the loop and above the tool, such that the tool can not be passed through the loop, thereby bypassing the safety mechanism. The tool can be a powered wrench or powered screwdriver adapted to tighten an attachment member, such as for example a threaded bolt, for attaching the selected body to the selected chassis. Again, the assembly station and the collection station can be combined into one station where the chassis styles can be stored under the work bench.

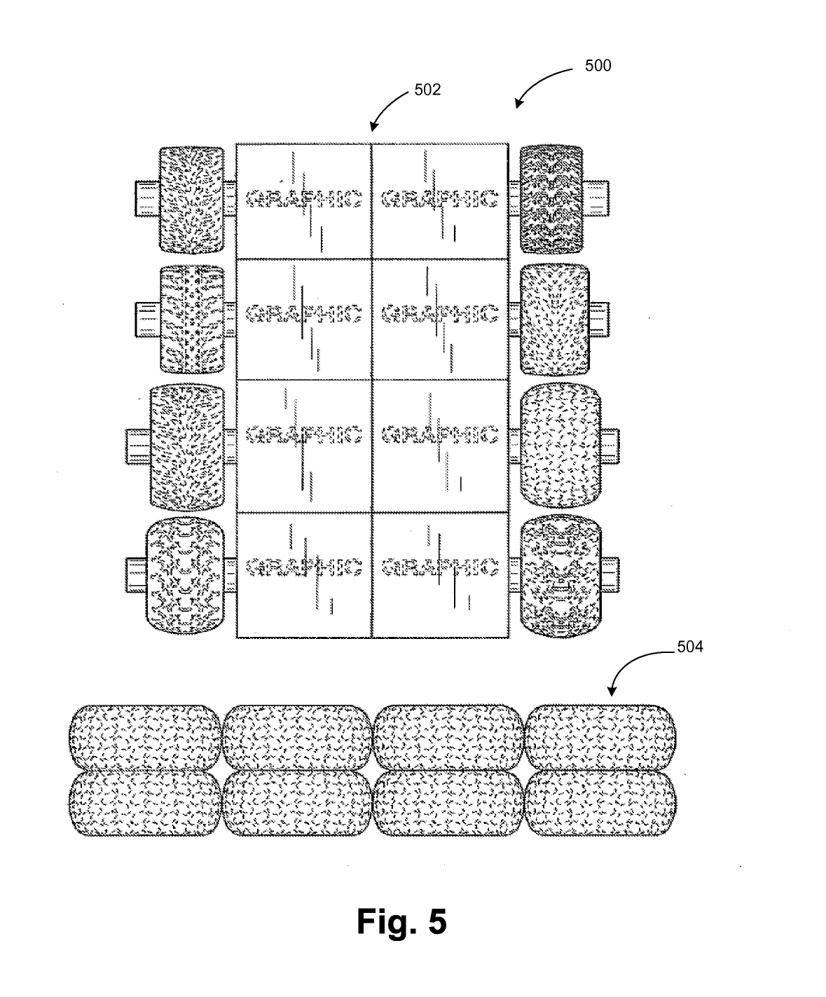

Referring to FIG. 5, an illustration of an example display is shown. The accessory station 500 is shown having a display board 502 for displaying accessories as well as having full size tire and rim displays and having storage display bins 504. The accessory station can also include a workbench for the customer to sample and install accessories. The personalization station can have multiple computer workstations that the customer can utilize to proceed through the personalization process.

The various modular toy vehicle designs and custom assembly examples shown above illustrate a novel apparatus and method for allowing a consumer to select and customize a toy vehicle and assembly the selected components in a retail environment. A user of the present invention may choose any of the above embodiment, or an equivalent thereof, depending upon the desired application. In this regard, it is recognized that various forms of the subject in-store consumer assembly process for a modular toy vehicle design could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the sprit and scope of the present invention.

Other aspects, objects and advantages of the present invention can be obtained from a study of the drawings, the disclosure and the appended claims.

What is claimed is:

1. A method of providing a user with a toy purchasing experience, the method comprising:
providing a customized toy assembling area allowing the user to assemble a customized toy by selecting from a plurality of toy styles and optional accessories;
providing electronically readable identifiers that identify the selected toy style and optional accessories;
reading the electronically readable identifiers at a first computer and generating an electronic profile for the user based on the readable identifiers, wherein the electronic profile comprises a computer generated image of the customized toy that is based on the selected toy style and optional accessories; and
providing the electronic profile to the user at a second computer.

2. The method of claim 1, where the customized toy is a customized toy vehicle and the plurality of toy styles includes a toy vehicle body selected from among various style bodies assembled to a toy vehicle chassis selected from among various toy vehicle chassis styles.

3. The method of claim 1, where the electronically readable identifiers are encoded bar codes and the reading the identifiers comprises electronically scanning the encoded bar codes.

4. The method of claim 1, where the electronic profile includes an alphanumeric nickname entered.

5. The method of claim 1, where providing the electronic profile comprises electronically retrieving and graphically displaying the computer generated image.

6. The method of claim 1, where providing the electronic profile comprises electronically transmitting a data copy of the computer generated image to another party.

7. The method of claim 2, wherein the customized toy assembling area comprises a powered wrench adapted to attach the toy vehicle body to the toy vehicle chassis using a bolt.

8. An apparatus that provides a user with a toy purchasing experience, the apparatus comprising:
a reading device for reading electronically readable identifiers from a customized toy that is assembled at a customized toy assembling area that allows a user to assemble the toy by selecting from a plurality of toy styles and optional components, wherein the electronically readable identifiers identify the selected toy style and optional accessories;
a processor that generates an electronic profile for the user based on the readable identifiers, wherein the electronic profile comprises an a computer generated image of the customized toy that is based on the selected toy style and optional accessories; and
a communication device for providing the electronic profile to the user at a second computer.

9. The apparatus of claim 8, where the customized toy is a customized toy vehicle and the plurality of toy styles includes a toy vehicle body selected from among various style bodies assembled to a toy vehicle chassis selected from among various toy vehicle chassis styles.

10. The apparatus of claim 8, where the electronically readable identifiers are encoded bar codes and the reading the identifiers comprises electronically scanning the encoded bar codes.

11. The apparatus of claim 8, where the electronic profile includes an alphanumeric nickname entered.

12. The apparatus of claim 8, where providing the electronic profile comprises electronically retrieving and graphically displaying the computer generated image.

13. The apparatus of claim 8, where providing the electronic profile comprises electronically transmitting a data copy of the computer generated image to another party.

14. The apparatus of claim 9, wherein the customized toy assembling area comprises a powered wrench adapted to attach the toy vehicle body to the toy vehicle chassis using a bolt.

15. A computer readable medium having instructions stored thereon that, when executed by a processor, causes the processor to provide a user with a toy purchasing experience for a toy that is assembled by allowing the user to select from a plurality of toy styles and optional accessories, the instructions comprising:
reading electronically readable identifiers at a first computer, wherein the electronically readable identifiers identify the selected toy style and optional accessories;
generating an electronic profile for the user based on the readable identifiers, wherein the electronic profile comprises an Avatar, wherein the Avatar is a computer generated image of the customized toy that is based on the selected toy style and optional accessories; and
providing the electronic profile to the user at a second computer.

16. The computer readable medium of claim 15, where the customized toy is a customized toy vehicle and the plurality of toy styles includes a toy vehicle body selected from among various style bodies assembled to a toy vehicle chassis selected from among various toy vehicle chassis styles.

17. The computer readable medium of claim 15, where the electronically readable identifiers are encoded bar codes and the reading the identifiers comprises electronically scanning the encoded bar codes.

18. The computer readable medium of claim 15, where the electronic profile includes an alphanumeric nickname entered.

19. The computer readable medium of claim 15, where providing the electronic profile comprises electronically retrieving and graphically displaying the computer generated image.

20. The computer readable medium of claim 15, where providing the electronic profile comprises electronically transmitting a data copy of the computer generated image to another party.
